(19) United States
(12) Patent Application Publication
(10) Pub. No.: US 2007/0133526 A1
(43) Pub. Date: Jun. 14, 2007

(54) Remote access communication system and control method thereof

(75) Inventors: Jingfan Ma, Shenzhen (CN); Shikui Huang, Shenzhen (CN)

Correspondence Address: Robert Popa, Esq.;c/o LADAS & PARRY, Suite 2100, 5670 Wilshire Boulevard, Los Angeles, CA, 90036-5679, US

(73) Assignee: HUAWEI TECHNOLOGIES CO., LTD.

(21) Appl. No.: 11/636,239

(22) Filed: Dec. 8, 2006

(30) Foreign Application Priority Data
Dec. 13, 2005 (CN) 200510120815.4

(51) Int. Cl. H04Q 11/00

(52) U.S. Cl. 370/380; 379/219

(57) ABSTRACT

The present invention discloses a remote access Communication system, which includes an automated main distribution frame, a remote access device and a device management system. Under control of the device management system, the automated main distribution frame and the remote access device implement auto port-correspondence between a user and the remote access device, therefore accomplishing automatic switch function. The present invention also provides a control method utilizing the above system, in which after receiving a configuration command and verifying the command, the main distribution frame configures a switch module, therefore accomplishing an automatic switch system. The present invention reduces operation costs effectively and improves speed of service fulfillment.

### FIELD OF THE INVENTION

The present invention relates to network communication technology, and particularly to a remote access communication system and a control method thereof.

### BACKGROUND OF THE INVENTION

Remote communication access network, as one of the most important network infrastructures for present telecom network devices, connects local network communication exchanges with users, responsible for transmitting various telecom services to the users transparently. Various services are provided to end users by various service networks mostly through access networks, so access networks must satisfy various service networks' requirements for access users and users' needs for a broad range of services. A future access network will be one capable of providing high-capacity, high-rate, and high-quality integrated services (data, video, voice, multimedia, etc).

Generally a remote access Communication system locates at the end of a telecom network, serving as a window for the telecom network to provide services to users. A remote access Communication system covers all devices and transmission media from service provision points to user ports. In general, a prior remote access Communication system is mainly composed of a main distribution frame (MDF), an access network unit (ANU) and other auxiliary devices, referring to FIG. 1. All device modules are placed in a cabinet and are connected to the outside through cables or optical cables. A remote access device accomplishes access of user communication data, and performs data conversion or aggregation before transmitting the data to an upper layer network through uplink interfaces. The main distribution frame implements a mapping between Communication device ports and user lines outside.

A main distribution frame is placed between network devices and user ports, responsible for match connection between device cables and user cables. An MDF is composed of an exterior line module (horizontal module), an interior line module (vertical module) and connection lines between the exterior line module and the interior line module; different correspondence between interior line module ports and exterior line module ports can be obtained through selecting different line connections.

The remote access device can be a local exchange, a narrowband access device, a digital subscriber line access multiplexer (DSLAM), a fiber access device, and can also be an integrated access device providing access to narrowband services and broadband services access simultaneously.

Other auxiliary devices include a device power supply system (active/standby power supply system), a thermostat, and an alarm device, etc. The power supply system provides power supply for operations of the remote access device and the main distribution frame. Generally the power supply system includes two modules: an active module and a standby module. The active module is a primary power supply, which converts a civil electric supply into a power supply for system operation through voltage conversion; the standby module is commonly a battery pack, which provides a required power supply for communication devices when the civil electric supply fails. The thermostat is responsible for adjusting interior temperature of the outdoor cabinet, ensuring that the interior temperature of the cabinet meets operation requirements of the remote access device, the main distribution frame and etc. The alarm device monitors operation situations of all devices in the cabinet, and other situations, such as humidity, temperature, waterlogging, etc.

With the development of technologies, El access, optical fiber access, etc. have become universal access modes in the access field; and correspondingly a digital distribution frame (DDF) and an optical distribution frame (ODF) have been put into use with the development of the main distribution frame technology. But when a remote access device performs maintenance operations, such as service fulfillment for a new user, new service addition, relocation or number change for a present user, a general method is to modify the user's configuration data in the device firstly, and then change corresponding relationships between internal line modules and external line modules in the main distribution frame, accomplishing change of functions.

At present, a remote access Communication system generally can be located outdoors, on a roadside, or in a basement, etc. When adding new users or adding new requirements of users, a maintainer has to go to remote field locations to allocate number for users and fulfill users' service requirements through jumping wires in the MDF. Even a single user's new service requirement or service fulfillment requirement would need a special trip to remote field locations for maintenance operations. Such frequent and lots of maintenance operations result in high labor cost. More importantly, none of the services can be fulfilled in real time, and operations such as service fulfillment need a longer process and period, which makes. it difficult to improve service response and service quality to users.

### SUMMARY OF THE INVENTION

The embodiment of the present invention provides a remote access Communication system and a control method thereof.

A remote access Communication system, including an automated main distribution frame (AMDF), a remote access device and a device management system, wherein, under control of the device management system, the automated main distribution frame and the remote access device implement auto port-correspondence between a user device and the remote access device, therefore accomplishing automated switch function.

In the present invention, the automated main distribution frame includes a matrix switch module, an inlet module and an outlet module connected with the matrix switch module respectively, and an automated main distribution frame controller connected with the above three modules and used to start and configure the automated main distribution frame, wherein input ports of the inlet module are to be connected with user devices by cables and output ports of the outlet module are to be connected with the remote access device through cables.

The remote access device is a local switch.

The remote access device is a narrowband access device or a broadband access device.

The remote access device is a DSLAM access device.

The remote access device is an optical access device.

The embodiment of the present invention further provides a control method of a remote access Communication system, according to which an automated main distribution frame is arranged between user devices and a remote access device, and under control of a device management system, the automated main distribution frame and the remote access device implement auto port-correspondences between a user and the device, therefore accomplishing automated switch function.

The above step of accomplishing auto port-correspondence between the user and the remote access device includes the following steps:

1) if there is a service requirement from the user, the device management system sends a configuration command to the automated main distribution frame;

2) after receiving the configuration command, the automated main distribution frame verifies validity of the configuration command;

3) if the verification succeeds, the automated main distribution frame configures a matrix switch module therein according to the configuration command, in order to achieve a port correspondence between the user and the remote access device; or

4) if the verification fails, the automated main distribution frame sends a warning to the device management system, and the device management system determines whether to resend a command or to perform other operations according to the warning feedback.

In an embodiment of the present invention, the method for verifying validity of the configuration command includes a step of verifying truth or falsity of contents of a command field by the automated MDF controller.

In another embodiment of the present invention, the method for verifying validity of the configuration command includes a step of examining rationality of configuration data of a command field.

In still another embodiment of the present invention, the method for verifying the validity of the configuration command includes a step of examining integrality of configuration data of a command field.

In an embodiment of the present invention, the device management system sends a configuration command to the automated main distribution frame through network management.

Compared with prior art, the present invention has the following effects:

1. Operating costs are reduced. Operations of jumping wires in the remote access Communication system can be directly and rapidly implemented under remote control of the device management system, so time is saved and there is no need to arrange staff for on-site operation, greatly reducing operation and maintenance cost and labor cost;

2. Speed of service fulfillment is increased. Since manual on-site operation is replaced by network management operation, a work of several days before can be finished most likely in several minutes using the embodiment of present invention, greatly improving speed of service fulfillment.

3. Because of the use of an automated main distribution frame connected with the remote access device, the automated main distribution frame completes wire jumpings at one time, avoiding any confusion caused by more irregular wire jumping in traditional methods, so a beautiful and orderly main distribution frame is achieved.

4. Because of the use of a device management system, wire jumping operations caused by number portable, number change and engineering line shifts can be completed locally or through a network management system, simplifying multiple wire jumping; and also avoiding loose and fall of sticking points in the main distribution frame caused by multi-clamping operations, therefore reducing occurrence of failures.

### BRIEF DESCRIPTIONS OF THE DRAWINGS

FIG. 1 is a diagram illustrating a structure of a remote access Communication system in prior art;

FIG. 2 is a block diagram of a remote access Communication system described in an embodiment of the present invention;

FIG. 3 is a flow chart of a control method of an embodiment of the present invention;

FIG. 4 is a diagram illustrating an application mode in an embodiment of the present invention;

FIG. 5 is diagram illustrating another application mode in the embodiment of the present invention.

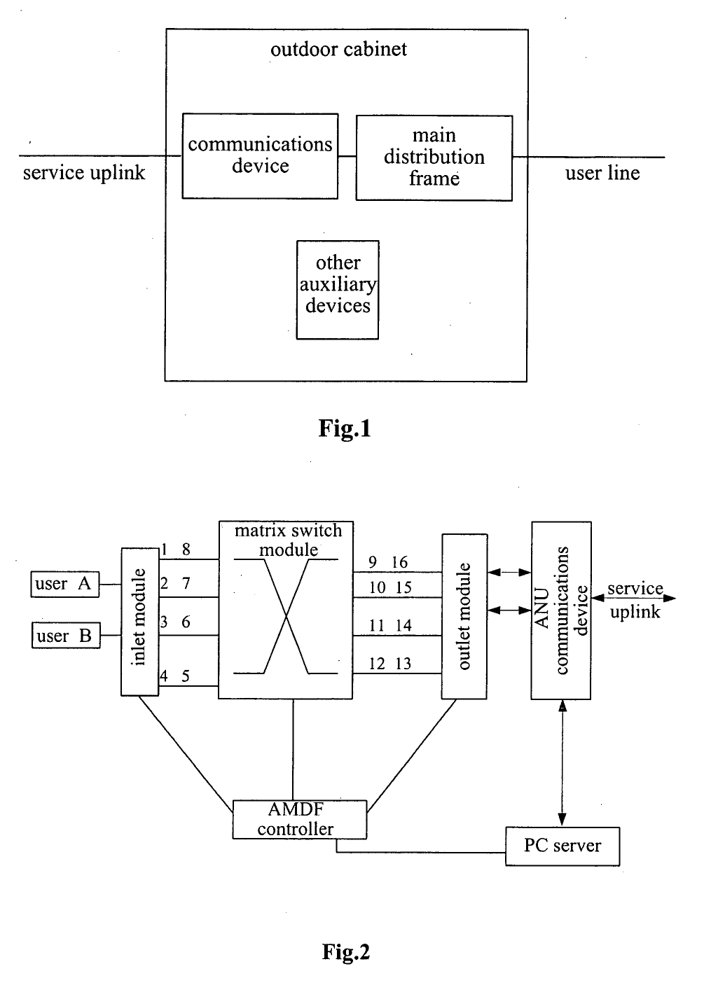

### DETAILED DESCRIPTIONS OF THE EMBODIMENTS

The embodiments of the present invention will be further described in conjunction with the accompanying drawings.

As shown in FIG. 2, a remote access communication system described in an embodiment of the present invention includes an automated main distributed frame, a remote access device for transparently transmitting various telecom services to users, and a device management system. Under control of the device management system, the automated main distribution frame and the remote access device implement auto port-correspondence between a user device and the remote device, and therefore accomplish automatic switch function.

The automated main distribution frame includes a matrix switch module, an inlet module and an outlet module connected with the matrix switch module respectively, and an automated main distribution frame controller connected with the above three modules and adapted to start and configure the automated main distribution frame. Input ports of the inlet module are connected to user devices by cables, and output ports of the outlet module are connected to the remote access device by cables.

In practical applications, there may be a certain convergence ratio between ports of the remote device and ports of user, which can be implemented through port configurations in an AMDF.

A remote access device serves as a window for a telecom network to provide services to users, which can be a local exchange, a narrowband access device, a broadband access device, a DSLAM access device, an optical access transmission device or a combination of the above devices, such as an integrated access device providing access to narrowband services and broadband services access simultaneously. It is responsible for transmitting transparently various telecom services to users, accomplishing user access, service fulfillment and switching.

The embodiment of the present invention also provides a control method utilizing the above remote access Communication system, the detailed steps thereof are as follows:

1) when there is a service requirement from a user, the device management system sends a configuration command to the automated main distribution frame through network management;

2) upon receiving the configuration command, the automated main distribution frame firstly verifies validity of the configuration command, which includes steps of verifying authentication of contents of a command field, examining rationality of configuration data in the command field, and examining integrality of the configuration data in the command field, etc. If the verification succeeds, the automated main distribution frame configures the matrix switch module according to the configuration command, to achieve a port correspondence between the user and the remote access device. If the verification fails, the automated main distribution frame does not work, and it sends a warning to the device management system, to indicate that it receives an illegal command the device management system determines whether to resend the command or to perform other operations according to the warning feedback.

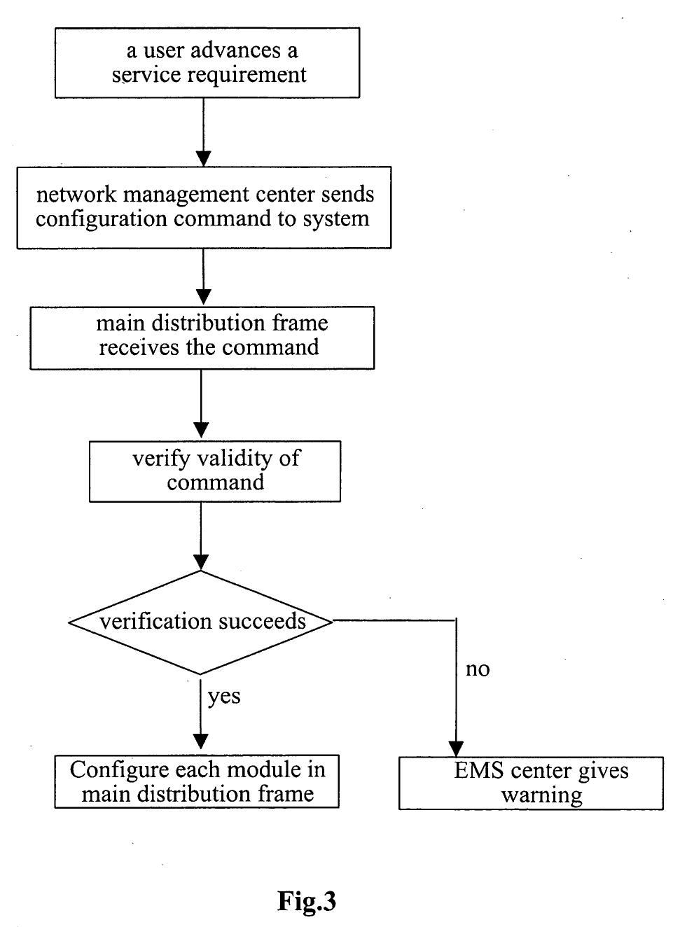

To describe the automated distribution method of the system of the embodiment of the present invention, we take a telephone system being widely used at present as an example. As shown in FIGS. 2 and 3, a lot of user ports are connected to the inlet module of the AMDF through twisted-pairs, i.e. communication cables of user board are connected to a port on one side of the AMDF; if user B (3-6, 4-5 user lines) requests for common broadband service, the device management system can be used to send a configuration command through local network management or remote network management. Upon receiving the configuration command, the AMDF firstly verifies validity of the configuration command, which includes the steps of verifying truth or falsity of contents of a command field, examining rationality of configuration data of the command field and integrality of the configuration data of the command field, etc. If the verification succeeds, the AMDF configures the matrix switch module according to the command, and connects lines 3-6, 4-5 on the side of user B(i.e. the side of the inlet module) to the corresponding lines 11-14, 12-13 on the side of the remote access device(i.e. the side of the outlet module), i.e. a twist-pair of the user is connected to a certain port of the device cables, so that the user terminal device is connected to the remote access device, and mutual communications with ANU achieves the purpose of service fulfillment for the user, and therefore accomplishes service fulfillment. The device control system, upon implementing of management software therein, can manage services directly and locally through on-site management of configuration interfaces by the AMDF, and can also manage service fulfillment remotely, to achieve auto service fulfillment.

Remote management refers to implementing device management, service fulfillment and maintenance, etc utilizing an ANU Communication device and uplink service channels provided within an automated main distribution frame, in which information is provided to a network management system through service channels. The ANU Communication device provides a network management interface, and communicates with the ANU Communication device and the automated main distribution frame by using Simple Network Management Protocol (SNMP).

A PC server, adopting local or remote client-server architecture, can easily implement local network management and centralized network management.

When more users access to a remote access device, the space in a cabinet may be a bottleneck for applications. In such a situation, the following two modes can be adopted:

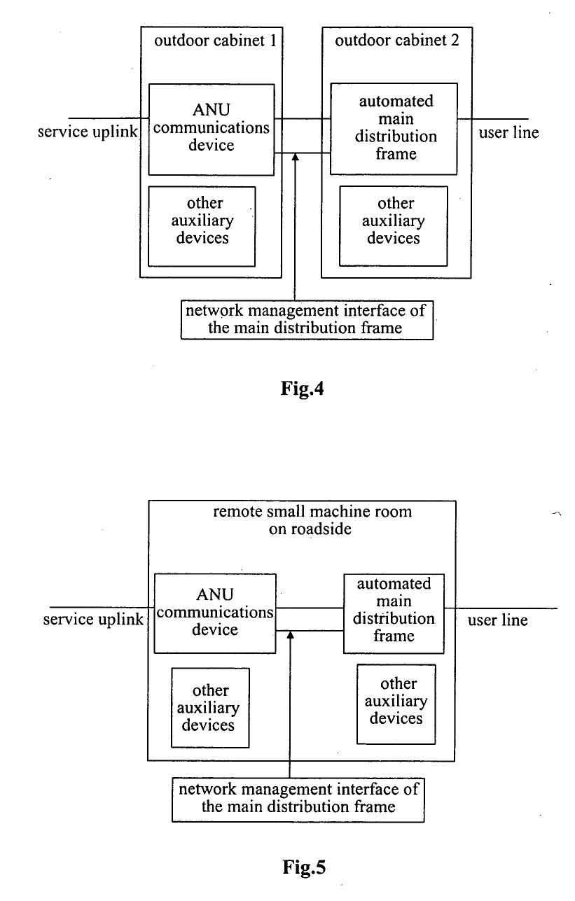

Mode one: referring to FIG. 4, the capacity reaches a certain amount, due to limitation of the cabinet capacity, the remote access device and the automated main distribution frame can be placed in two cabinets which are connected with each other through cables;

Mode two: referring to FIG. 5, when the number of users increases again, all devices can be located in a small house on a roadside. The logical relationships between the devices are unchanged.

Though the present invention has been illustrated and described by referring to some preferred embodiments of the present invention, those skilled in the art should understand that various changes may be made in form and detail without departing from the spirit and the scope of the present invention and therefore should be covered in the protection scope of the present invention defined by the appended claims and its equivalents.

1. A remote access Communication system, comprising an automated main distribution frame, a remote access device, and a device management system, wherein, under control of the device management system, the automated main distribution frame and the remote access device implement auto port-correspondence between a user device and the remote access device, to accomplish automatic switch function.

2. The system according to claim 1, wherein-said automated main distribution frame comprises a matrix switch module, an inlet module and an outlet module connected with the matrix switch module respectively, and an automated main distribution frame controller, which is connected with the matrix switch module, the inlet module and the outlet module, used to start and configure the automated main distribution frame, input ports of the inlet module are connected with user device by cables and output ports of the outlet module are connected with the remote access device by cables.

3. The system according to claim 1, wherein said remote access device is a local exchange.

4. The system according to claim 1, wherein said remote access device is a narrowband access device or a broadband access device.

5. The system according to claim 1, wherein said remote access device is a digital subscriber line access multiplexer.

6. The system according to claim 1, wherein said remote access device is a fiber access device.

7. The system according to claim 1, wherein said remote access device is an integrated access device providing access to narrowband services and broadband services access simultaneously.

8. A method for controlling a remote access Communication system, comprising:
arranging an automated main distribution frame between user devices and a remote access device, and
implementing auto p6rt-correspondence between a user and the remote access device by the automated main distribution frame and the remote access device under control of a device management system, therefore accomplishing automatic switch function.

9. A method for controlling a remote access Communication system according to claim 8, wherein implementing auto port-correspondence, between a user and the remote access device comprises:
1) sending a configuration command to said automated main distribution frame when there is a service requirement from a user;
2) verifying validity of the configuration command after receiving the configuration command;
3) if the verification succeeds, configuring a matrix switch module therein according to the configuration command to implement the port correspondence between the user and the remote access device; or
4) if the verification fails, sending a warning to the device management system, which determines whether to resend the command or to perform other operations according to the warning feedback.

10. A method for controlling a remote access Communication system according to claim 9, wherein verifying validity of the configuration command comprises verifying authentication of contents of a command field.

11. A method for controlling a remote access Communication system according to claim 9, wherein verifying validity of a configuration command comprises examining rationality of configuration data in a command field.

12. A method for controlling a remote access Communication system according to claim 9, wherein verifying validity of a configuration command comprises examining integrality of configuration data in a command field.

13. A method for controlling a remote access Communication system according to claim 8, wherein said device management system sends a configuration command to said automated main distribution frame through network management.

14. A method for controlling a remote access Communication system according to claim 9, wherein said device management system sends the configuration command to said automated main distribution frame through network management.
